(19) United States
(12) Patent Application Publication
(10) Pub. No.: US 2012/0155788 A1
(43) Pub. Date: Jun. 21, 2012

(54) BAG WITH CLOSURE MECHANISM MOUNTED BY CONTRASTING ADHESIVE MATERIALS

(75) Inventors: Michael L. Iannelli, II, Thompsons Station, TN (US); Robert Owens, Kansas City, MO (US)

(73) Assignee: GRAPHIC PACKING INTERNATIONAL, INC., Marietta, GA (US)

(21) Appl. No.: 13/235,759

(22) Filed: Sep. 19, 2011

Related U.S. Application Data
(60) Provisional application No. 61/384,361, filed on Sep. 20, 2010.

(51) Int. Cl. B65D 33/16; B31B 1/90

(52) U.S. Cl. 383/64; 493/213

(57) ABSTRACT

A zipper member type of closure mechanism is mounted to a bag by adhesive materials having contrasting characteristics selected for providing advantages. The closure mechanism is mounted proximate an opening of the bag, so that the closure mechanism is positioned for use in opening and closing the bag.

### CROSS-REFERENCE TO RELATED APPLICATION

This application claims the benefit of U.S. Provisional Application No. 61/384, 361, which was filed on Sep. 20, 2010.

### INCORPORATION BY REFERENCE

The entire contents of U.S. Provisional Application No. 61/384, 361, which was filed on Sep. 20, 2010, is incorporated herein by reference.

### BACKGROUND

It is known for a bag to include an adhesively mounted closure mechanism, and for the closure mechanism to be a so-called zipper or slider. Problems may be experienced with bags having adhesively mounted closure mechanisms. For example, during or after assembly of a bag with a closure mechanism, desired adhesive bonds may not form adequately if sufficient care is not taken during the curing or other activation of the adhesive material. As another example, adhesive bonds may fail during use of a bag that is exposed to too much stress. Adhesive bonds may also fail if a bag is exposed to temperatures that are outside the range of service of the adhesive material. Losses may be experienced in the form unusable bags and/or spillage of bag contents.

### BRIEF SUMMARY

In accordance with one aspect of this disclosure, a closure mechanism is mounted to a bag by adhesive materials having contrasting characteristics that seek to enhance attribute(s) associated with performance of the bag and/or streamline assembly and/or handling of the bag. The closure mechanism is mounted proximate an opening of the bag, so that the closure mechanism is positioned for use in opening and closing the bag.

In accordance with an exemplary embodiment of this disclosure, the contrasting adhesives comprise at least first and second adhesive materials. The first and second adhesive materials may be different types of adhesive materials such that they have different characteristics. For example, the first adhesive material may be a thermoset adhesive material, and the second adhesive material may be a thermoplastic adhesive material. A relatively small amount of the thermoset adhesive material may be used for relatively high strength and/or high temperature stability, and a relatively large amount of the thermoplastic adhesive material may be used for relatively quick adhesion and/or for lower temperature stability.

The first adhesive material may be in a first arrangement between the closure mechanism and the bag, and the second adhesive material may be in a second arrangement between the closure mechanism and the bag. The first and second arrangements may differ from one another such that they have different characteristics. For example, the first and second arrangements may be in different locations (e.g., one above the other) and/or have different patterns (e.g., a series of dots (e.g., individual bead drops) versus a stripe (e.g., an elongate, continuous bead)).

The contrasting adhesives may include one or more adhesive materials that are in addition to the above-mentioned first and second adhesive materials. Accordingly, this disclosure is not limited to there being only two adhesive materials that are contrasting with respect to one another.

In accordance with the exemplary embodiment, the closure mechanism includes first and second closure parts adapted for being releasably connected with one another, and the first and second closure parts are respectively mounted to opposite walls or other appropriate portions of the bag. For each of the first and second closure parts and the respective wall of the bag, the closure part may be mounted to the wall by the adhesive materials having contrasting characteristics, as discussed above.

The closure mechanism may be an interlocking closure that may more specifically be a zipper member. The first and second closure parts may be first and second interlocking parts that may more specifically be zipper profiles of the zipper member. A slider may be included for being moved back and forth along the zipper member for opening and closing the zipper member.

One aspect of this disclosure is the provision of a bag having a bag body with first and second bag portions; and a closure mechanism having a first closure part mounted to the first bag portion by adhesive materials having contrasting characteristics, and a second closure part mounted to the second bag portion. An opening to an interior of the bag may be at least partially defined between the first and second closure parts. The first and second closure parts may be configured for being releasably connected with one another to at least partially close the opening.

In accordance with one aspect of this disclosure, a bag includes a zipper member having a first zipper profile mounted to a first wall of the bag by at least both thermoplastic and thermoset adhesive materials positioned between the first wall and the first zipper profile, wherein a total amount of the thermoplastic adhesive material positioned between the first zipper profile and the first wall exceeds a total amount of the thermoset adhesive material positioned between the first zipper profile and the first wall; and a second zipper profile mounted to a second wall of the bag by at least both thermoplastic and thermoset adhesive materials positioned between the second wall and the second zipper profile, wherein a total amount of the thermoplastic adhesive material positioned between the second zipper profile and the second wall exceeds a total amount of the thermoset adhesive material positioned between the second zipper profile and the second wall. An opening to an interior of the bag may be at least partially defined between the first and second zipper profiles, and the first and second zipper profiles may be configured for being releasably interlocked with one another to at least partially close the opening.

In one aspect of this disclosure, a method of mounting at least part of a closure mechanism to part of a bag includes: applying first adhesive material to at least one of the part of the closure mechanism and the part of the bag; applying second adhesive material to at least one of the part of the closure mechanism and the part of the bag; forcing the part of the closure mechanism and the part of the bag together so that each of the first and second adhesive materials is positioned between, and in contact with both, the part of the closure mechanism and the part of the bag; the first adhesive material bonding the part of the closure mechanism and the part of the bag together; the second adhesive material bonding the part of the closure mechanism and the part of the bag together; and the bonding of the part of the closure mechanism and the part of the bag together by the first adhesive material occurring more quickly than the bonding of the part of the closure mechanism and the part of the bag together by the second adhesive material. Another closure part of the closure mechanism may be mounted to a second bag portion, wherein the closure parts are configured for being releasably connected with one another to at least partially close an opening to an interior of the bag.

At a predetermined time after the mounting of the part of the closure mechanism to the part of the bag: a bond defined by the second adhesive material between the part of the closure mechanism and the part of the bag may be stronger (e.g., per unit area and/or volume) than a bond defined by the first adhesive material between the part of the closure mechanism and the part of the bag; and/or a bond defined by the second adhesive material between the part of the closure mechanism and the part of the may have a different (e.g., greater) stability (e.g., high or lower temperature stability) (e.g., per unit area and/or volume) than a bond defined by the first adhesive material between the part of the closure mechanism and the part of the bag.

The foregoing presents a simplified summary of some aspects of this disclosure in order to provide a basic understanding. The foregoing is not an extensive summary and is not intended to identify key or critical elements of the invention or to delineate the scope of the invention. The purpose of the foregoing summary is to present some concepts of this disclosure in a simplified form as a prelude to the more detailed description that is presented later. For example, other aspects and advantages of this disclosure will become apparent from the following.

### BRIEF DESCRIPTION OF THE DRAWINGS

Having described some aspects of this disclosure in general terms, reference will now be made to the accompanying drawings, which may be schematic and are not necessarily drawn to scale. The drawings are exemplary only, and should not be construed as limiting the invention.

FIG. 1 is a front pictorial view of a bag without its upper closure mechanism and in an open configuration, in accordance with an exemplary embodiment this disclosure.

FIG. 2 is a front pictorial view of the bag with the upper closure mechanism mounted thereto and in an open configuration.

FIG. 3 is a front elevation view of the bag with the upper closure mechanism in a closed configuration.

FIG. 4 is an isolated, front elevation view of a rear zipper profile of the bag with contrasting adhesive materials thereon, wherein dashed lines schematically illustrate that the rear zipper profile may be part of a longer strip during assembling of the bag of FIGS. 2 and 3.

FIG. 5 is an isolated, rear elevation view of a front zipper profile of the bag with contrasting adhesive materials thereon, wherein dashed lines schematically illustrate that the front zipper profile may be part of a longer strip during the assembling of the bag.

FIG. 6 is a front pictorial view of the bag with the upper closure mechanism in the closed configuration, wherein dashed lines schematically illustrate some of the features that are hidden from view.

FIG. 7 is a rear pictorial view of the bag with the upper closure mechanism in the closed configuration, wherein dashed lines schematically illustrate some of the features that are hidden from view.

### DETAILED DESCRIPTION

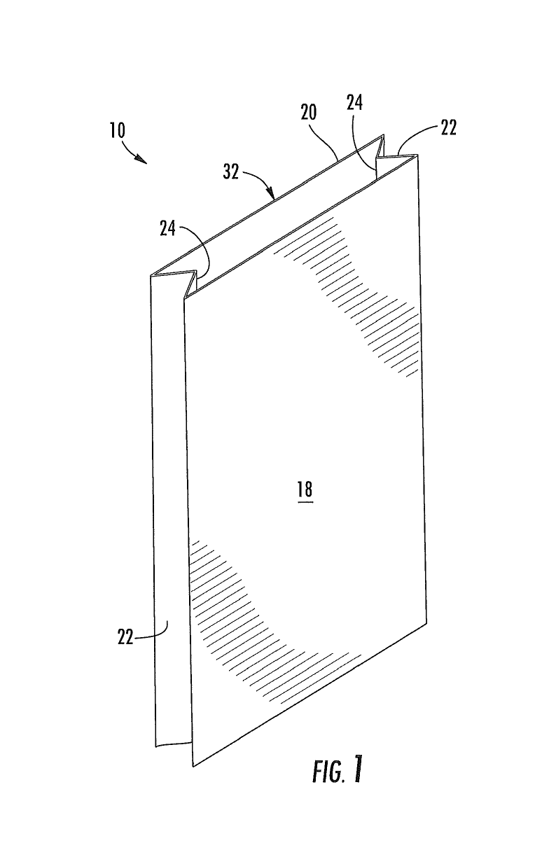

Referring now in greater detail to the drawings, in which like numerals refer to like parts throughout the several views, an exemplary embodiment is described in the following. FIG. 1 illustrates a multiwall bag 10 without its upper closure mechanism and in an open configuration. The bag 10 has a substantially tubular bag body with a closed lower end. The bag body may be conventional, and typically includes portions that may more specifically be in the form of a front wall 18, a rear wall 20 and optionally side walls 22. Optionally, each of the side walls 22 may include a central line of disruption, namely a fold line 24, so that the side walls comprise/are in the form of side pleats. As shown in FIG. 1, the bag 10 includes an open top 32 that is opposite from the closed bottom of the bag. The bottom may be closed (e.g., permanently sealed closed) in any suitable conventional manner. The open top 32 is open to the bag's interior. The interior of the bag 10 is configured to receive a product (not shown), such as any suitable conventional product that is conventionally contained in a bag.

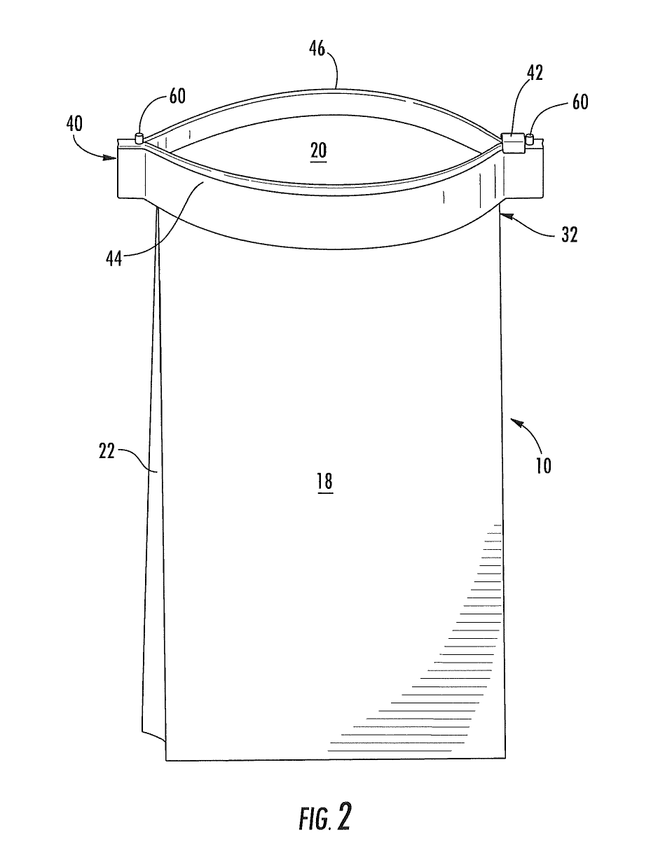

FIG. 2 illustrates the bag 10 with a zipper member 40 type of closure mechanism and an optional slider clip 42. As discussed in greater detail below, the bag 10 shown in FIG. 1 without the zipper member 40 and slider clip 42 may be characterized as being a bag body or a precursor bag to which the zipper member 40 and slider clip 42 are subsequently mounted.

As shown in FIG. 2, the zipper member 40 is mounted to the bag 10, and the zipper member optionally includes, or has mounted thereto, the slider clip 42. Therefore, the bag 10 may be characterized as including the zipper member 40 and the slider clip 42.

The zipper member 40 includes front and rear zipper profiles 44, 46 respectively mounted to the front and rear walls 18, 20 at the top 32 of the bag 10. The zipper profiles 44, 46 are closure parts that are adapted for being releasably connected (e.g., interlocked) with one another. In accordance with the exemplary embodiment, each zipper profile 44, 46 is a conventional polymeric extrusion that has a strip-like base and one or more elongate interlocking elements that extend along and protrude from the base. The zipper profiles 44, 46 are adapted for being releasably coupled to one another in a conventional manner. More specifically, elongate interlocking element(s) of one of the zipper profiles 44, 46 are adapted for being releasably coupled to the elongate interlocking element(s) of the other of the zipper profiles 44, 46 in a conventional manner. As an even more specific example, an elongate male interlocking element of one of the zipper profiles 44, 46 may be releasably received in the elongate female interlocking element of the other of the zipper profiles 44, 46 in a conventional manner.

The zipper member 40 is mounted to the top 32 of the bag 10 so that the bag may be opened by way of the zipper member 40 to access the product within the interior of the bag.

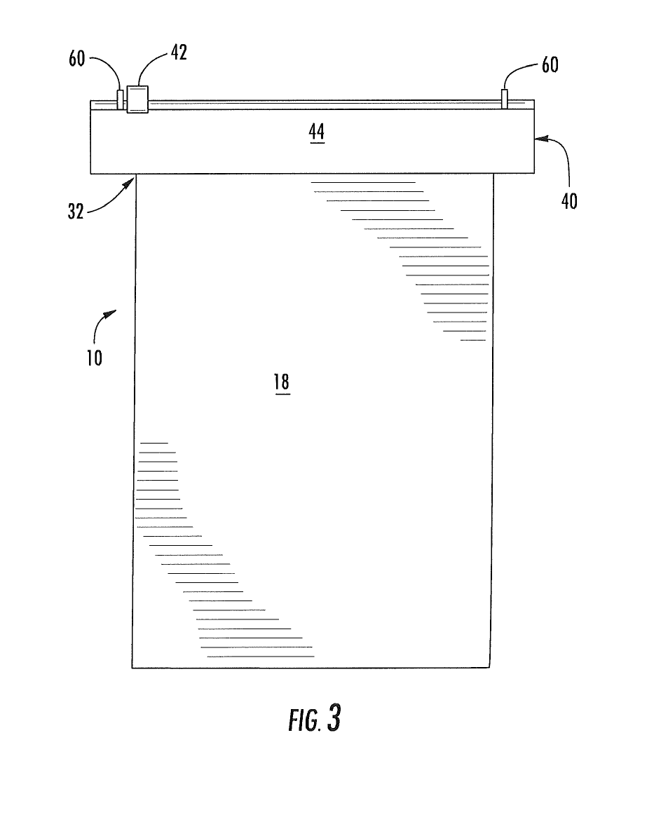

The zipper member 40 is open in FIG. 2, and the zipper member may be characterized as at least partially defining the upper opening to the interior of the bag 10. The top 32 of the bag 10 may be closed again, by way of the zipper member 40, to restrict access to the product within the interior of the bag. The zipper member 40 is closed in FIG. 3. That is, the zipper profiles 44, 46 are schematically shown as being releasably interlocked with one another for at least partially closing the upper opening of the bag in FIG. 3. The zipper member 40 is typically opened and closed using the optional slider clip 42. The slider clip 42 and its relationship to the zipper member 40 may be conventional.

In the exemplary embodiment, bag 10 includes conventional end stops 60 for limiting the range of motion of slider clip 42 along zipper member 40. The end stops 60 may be mounted to, and extend outwardly from, the zipper member 40. More specifically, the end stops 60 may extend outwardly from proximate the opposite ends of the zipper profiles 44, 46. The end stops 60 extend outwardly a distance to contact and arrest movement of the slider clip 42 as the slider clip is moved along the zipper member 40. The stops 60 may be glue drops (e.g., dried glue beads), clips, or any other suitable structures that may be applied to the zipper member 40 during fabrication of the bag 10.

The front zipper profile 44 is mounted to the outer surface of the front wall 18 of the bag 10, and the rear zipper profile 46 is mounted to the outer surface of the rear wall 20 of the bag. Alternatively, the zipper profiles 44, 46 may be attached to any other suitable surfaces of the bag 10, such as the inner surfaces of the front and rear walls 18, 20 of the bag 10. In the exemplary embodiment, each of the zipper profiles 44, 46 is mounted to the outer surface of the respective wall 18, 20 by adhesive materials having contrasting characteristics that seek to enhance attribute(s) associated with the bag 10 and/or streamline assembly and/or handling of the bag. Examples of methods for assembling the bag 10 are described in the following, in accordance with the exemplary embodiment of this disclosure.

A zipper member 40 may be mounted to a bag 10 in any suitable manner, such as through relatively slow manufacturing scenarios, including manual assembly. On the other hand, the mounting/assembling may be carried out using a relatively high speed machine that includes indexing and positioning automation equipment, as discussed in the following, in accordance with the exemplary embodiment.

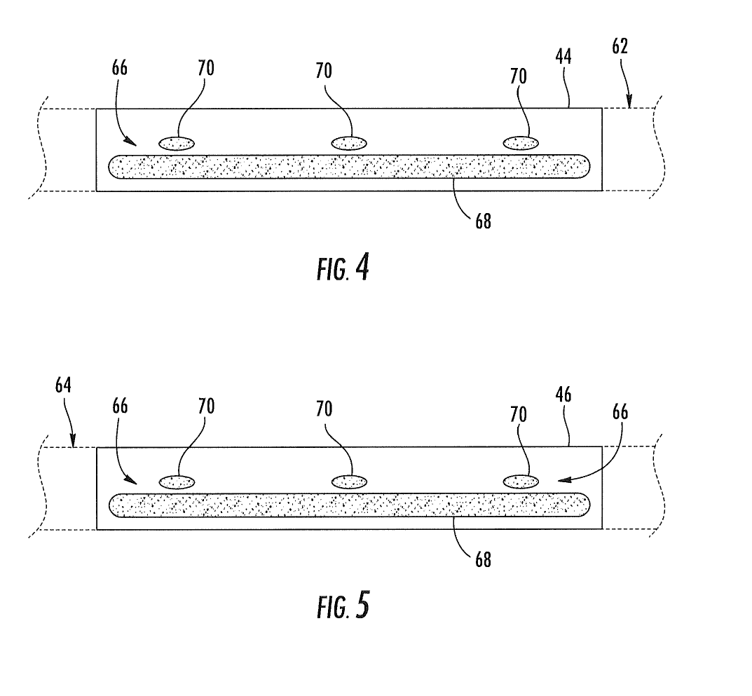

In accordance with the exemplary embodiment, inner surfaces of the front and rear zipper profiles 44, 46 respectively face the outer surfaces of the front and rear walls 18, 20. FIGS. 4 and 5 generally are isolated elevation views of the inner surfaces of the front and rear zipper profiles 44, 46 with adhesive materials 68, 70 thereon. Also, FIGS. 4 and 5 schematically illustrate with dashed lines that the zipper profiles 44, 46 are initially parts of longer strips of material 62, 64 during the assembly process. The strips of material 62, 64 from which the zipper profiles 44, 46 are cut may be conventional, and they may be drawn from rolls or any other suitable source(s) in a conventional manner.

For each of the strips 62, 64, automated adhesive applicators are positioned along the path that the strip is drawn. In isolation, each of the automated adhesive applicators may be conventional. However, in the exemplary embodiment, the automated adhesive applicators are positioned relative to one another, and supplied with different adhesive materials, in a manner that provides advantages. For example and in accordance with the exemplary embodiment, for each of the strips 62, 64, there may be two automated adhesive applicators, wherein the discharge ports of the adhesive applicators may be proximate one another, or more specifically adjacent to one another, or more specifically arranged one above the other for supplying the adhesive material 68, 70 onto the strips in the manner discussed in greater detail below.

The automated adhesive applicators are adapted for substantially simultaneously dispensing a combination of adhesive materials (“combination 66”). In accordance with the exemplary embodiment, the adhesive materials of the combination 66 have contrasting characteristics that seek to enhance attributes associated with the bag 10 and/or streamline assembly of and/or handling of the bag. The combination 66 typically includes two or more adhesive materials (e.g., two or more different types of adhesive materials). In accordance with the exemplary embodiment, the automated adhesive applicators are adapted for substantially simultaneously dispensing both an elongate bead (e.g., a continuous bead) of thermoplastic adhesive material 68 (e.g., a hot melt adhesive) and a series of dots (e.g., individual bead drops) of thermoset adhesive material 70 (e.g., epoxy adhesive) on the inner surfaces of the front and rear zipper profiles 44, 46. Accordingly, for the exemplary embodiment, the adhesive materials 68, 70 of the combination 66 are of contrasting types and are in contrasting amounts and arrangements (e.g., in different positions and/or different patterns). The adhesive materials 68, 70 are applied in serial fashion along the lengths of the strips 62, 64 from which a series of the zipper profiles 44, 46 will be respectively cut, as discussed in greater detail below. Any suitable adhesive applicators in any suitable arrangement may be used.

A series of the bags 10 without zipper members 40 (e.g., conventional “precursor bags” or “bag bodies”, as shown in FIG. 1) may be feed (in any suitable (e.g., conventional) manner) between the strips 62, 64 from which the zipper profiles 44, 46 are cut. Alternatively, one or more of the adhesive materials 68, 70 may be initially applied to the bags 10 by the automated adhesive applicators, rather than being initially applied to the strips 62, 64 that the zipper profiles 44, 46 are part of.

The source of the precursor bags 10 being feed between the strips 62, 64 may be a conventional bag feeder. The bag feeder may feed the precursor bags 10 individually onto a conventional registration table. The registration table may align and position the precursor bags 10 squarely and consistently as the precursor bags are transferred downstream to the remaining components of the assembling equipment. Specifically, the registration table aligns each precursor bag 10 parallel to each other precursor bag 10 and aligns the tops 32 of the precursor bags 10. As such, the tops 32 of the precursor bags 10 are positioned to receive the zipper profiles 44, 46 of the strips 62, 64. As the precursor bags 10 are accepted onto the registration table, the precursor bags 10 are consistently spaced from a trailing edge of one precursor bag 10 to a leading edge of another precursor bag 10 (i.e., a consistent spacing is provided between the side walls 22 of adjacent precursor bags 10).

Transporting members, which may be conventional, cooperate with the registration table for aligning, securing and transporting the precursor bags 10 and maintaining the relative positions of the precursor bags 10. The transporting members may include belts, such as endless conveyor-type belts, that are positioned on opposing sides of and engaging the precursor bags 10, thus securing the precursor bags 10 therebetween. Also, the transporting members facilitate transferring the precursor bags 10 downstream to the remaining components of the assembling equipment.

At a zipper applicator, which may be conventional, zipper profiles 44, 46 are substantially simultaneously attached to each bag 10. More specifically, typically each bag 10 is positioned between and attached to the longer strips 62, 64 that the zipper profiles 44, 46 are part of. Each bag 10 is adhered to the adhesive materials 68, 70 on the strips 62, 64 that the zipper profiles 44, 46 are part of. In the exemplary embodiment, for each of the zipper profiles 44, 46, the adhesive materials 68, 70 are positioned between the zipper profile and the respective portion or wall of the bag 10. At the zipper applicator, the zipper profiles 44, 46 and each bag 10 are typically nipped or otherwise forced or pressed together so that the bag becomes adhered to the zipper profiles.

The end sections of the zipper profiles 44, 46 that extend beyond the side edges of the bag 10 are typically pinched (e.g., nipped or otherwise pressed) together so that the end sections of the zipper profiles 44, 46 become adhered to one another by the thermoplastic adhesive material 68. As best understood with reference to FIGS. 4 and 5, for each elongate/continuous bead of thermoplastic adhesive material 68, each end of the bead is typically recessed a sufficient distance (e.g., a short distance) from the respective end of the respective zipper profile 44, 46 in a manner that seeks to prevent squeeze out of the thermoplastic adhesive material during the pinching together of the zipper profiles. Alternatively, the ends of the beads of the thermoplastic adhesive material 68 may be farther recessed from the ends of the zipper profiles 44, 46 and the end sections of the zipper profiles 44, 46 may be joined to one another in any other suitable manner (e.g., by an ultrasonic sealer), or the end sections of the zipper profiles 44, 46 may not extend beyond the side edges of the bag 10.

After the zipper profiles 44, 46 are adhesively mounted to the bag 10 to form the zipper member 40, the slider clip 42 and end stops 60 may be mounted to the zipper member 40 in a conventional manner. For example, the end stops 60 may be clip or clip-like features that are mounted to the zipper member 40. Alternatively, the end stops 60 may be cured or otherwise solidified beads of adhesive material (e.g., glue drops) that are mounted to the zipper member 40.

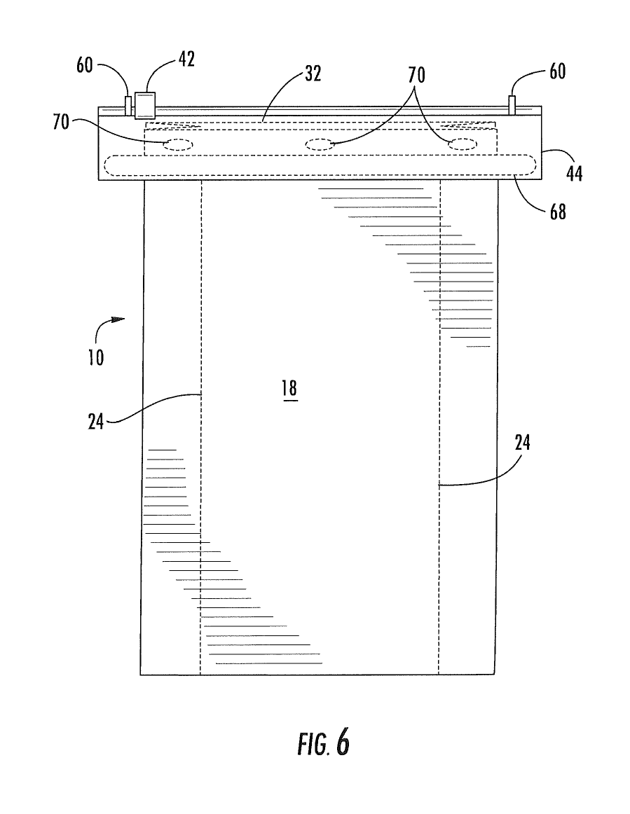

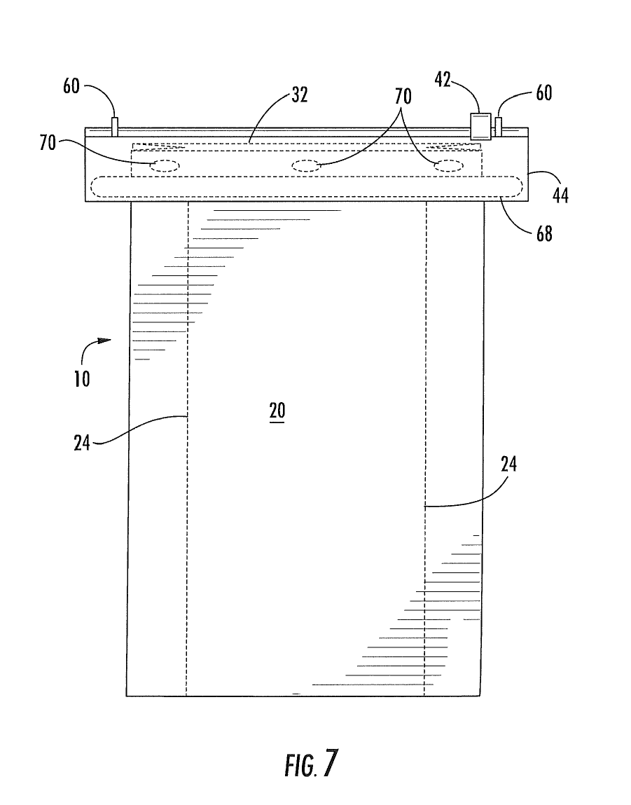

In the exemplary embodiment, the bags 10 are transferred downstream from where the slider clip 42 and end stops 60 were installed to a conventional cutter. As indicated above, the zipper profiles 44, 46 are parts of the continuous strips 62, 64. Therefore, several of the zipper members 40 are part of a continuous web that extends between and connects the individual bags 10 to one another. The cutter facilitates cutting the ends of the zipper members 40 between the bags 10 so that the bags are no longer connected to one another. In this regard, FIGS. 6 and 7 schematically illustrate the adhesive materials 68, 70 of a completely assembled bag 10. More specifically, the adhesive materials 68, 70, bag top 32 and fold lines 24 are hidden from view in FIGS. 6 and 7, but they are schematically illustrated by dashed lines for illustrative purposes.

As mentioned above and in accordance with one aspect of this disclosure, the combination of adhesive materials (e.g., see the combination 66 in FIGS. 4 and 5) may comprise contrasting types of adhesive materials, contrasting positions of adhesive materials and/or contrasting patterns of adhesive materials. The provision of a wide variety of different contrasting characteristics between the combination of adhesive materials is within the scope of this disclosure. That is, only one of numerous possible arrangements and patterns of adhesive material(s) is illustrated in the drawings of this disclosure. The contrasting characteristics may be selected based upon a variety of factors, such as seeking to streamline assembly of and/or handling of the bag and/or seeking to enhance attributes associated with performance of the bag. The contrasting characteristics may vary as a function of time and/or one or more other suitable variables. Examples of possible issues to consider when selecting the contrasting characteristics include, but are not limited to, retention of products within the bags, strength of the bags (e.g., shipping strength), and factors associated with assembly (e.g., speed of assembly) and handling of the bags (e.g., how quickly the bags may be handled after assembly). For example, one aspect of the exemplary embodiment of this disclosure is the provision of improved bag performance and improved bag manufacturing efficiency and/or handling by using the contrasting adhesive materials 68, 70 in their contrasting positions and patterns.

As one example, the combination 66 of the adhesive materials 68, 70 may provide both high and low temperature stability. That is, the use of both the thermoplastic and thermoset adhesive materials 68, 70 seeks to provide both high and low temperature performance of the bag 10. According to one aspect of this disclosure, the thermoplastic adhesive material 68 may provide cold adhesion between the bag 10 and the zipper profiles 44, 46, and between the end sections of the zipper profiles 44, 46. In accordance with one aspect, the thermoset adhesive material 70 provides the high temperature stability to pass specific high temperature storage tests and improve field performance.

As another example, relatively fast tack (e.g., fast solidifying) of the thermoplastic adhesive material 68 may allow for substantially immediate handling of the bags 10 after assembly. More specifically, the thermoplastic adhesive material 68 may set (e.g., solidify) relatively quickly and improve the ability to handle, stack, and prepare for shipping substantially immediately after assembly of the bags 10. In contrast, depending upon the selected thermoset adhesive material, it may require twenty four to seventy two hours of curing before being suitable for handling, stacking, and preparation for shipping of empty bags assembled only with thermoset adhesive material. Therefore, one aspect of this disclosure is the provision of significantly improved operational efficiency. On the other hand, the thermoset adhesive material may be of a type that cures more quickly, such as by being a thermoset adhesive material that may be cured by ultraviolet light that is supplied at or proximate the above-discussed zipper applicator.

In accordance with the exemplary embodiment, the pattern in which the thermoset adhesive material 70 is applied allows for a relatively small amount of the thermoset adhesive material to be used, which reduces cost, while nonetheless favorable performance of the bags 10 is achieved. In addition, the positioning (e.g., relative positioning) of the thermoplastic and thermoset adhesive materials 68, 70 may be selected to provide beneficial results.

As mentioned above, only one of numerous possible arrangements and patterns of adhesive material(s) is illustrated in the drawings of this disclosure. As one example, one or each of the elongate/continuous beads of the thermoplastic adhesive material 68 may be replaced by a series of dots (e.g., individual bead drops) of the thermoplastic adhesive material. Similarly, one or each of the series of dots of the thermosetting adhesive material 70 may be replaced with an elongate/continuous bead of the thermosetting adhesive material 68. Also, whereas specific numbers of the dots of the thermosetting adhesive material 70 are shown in the drawings of this disclosure, a greater or lesser number of dots may be used. Other variations, such as variations in the arrangements (e.g., locations and/or patterns) of the adhesive materials 68, 70, are within the scope of this disclosure.

The assembling equipment may include one or more features for cooling one or more of the adhesive materials (e.g., the thermoplastic adhesive material 68) associated with the zipper member 40. For example, one or more cooling flows of air may be directed toward the zipper members 40 shortly after they have been mounted to the bags 10, such as for speeding the cooling and solidifying of the thermoplastic adhesive materials 68. Similarly, and depending upon the type of thermoset adhesive material 70 that is used, the assembling equipment may include one or more features that seek to aid in the curing of the thermoset adhesive material (e.g., for curing with heat and/or ultraviolet light).

The tubular body of the bag 10 may be formed from multiple layers or plies of material. For example, the bag 10 may include an inner plastic layer or ply (e.g., a film of bi-axially oriented polypropylene) that may be connected to an inner paper (e.g., Kraft paper) layer or ply (not shown), and an outer paper (e.g., Kraft paper) layer or ply may be connected to the inner paper layer or ply. One or more of the adjacent layers or plies of the bag 10 may be at least partially not directly joined to one another, may be only partially joined (e.g., adhered) to one another, or may be fully joined (e.g., adhered and/or laminated) to one another. In one example, the adjacent plies of the bag 10 are only attached (e.g., adhered) to one another at the top and bottom of the bag. However, a wide variety of differently configured bags are within the scope of this disclosure. For example, the bag 10 may include multiple layers and/or plies of polymeric and/or paper materials. Alternatively, the bag 10 may be constructed of a single layer of paper or plastic material, or have any other suitable construction. For example, the one or more layers or plies of the bag 10 may be or include a polymer film, polymeric coating, paper, woven material or nonwoven material, or any other suitable material.

The entire disclosure of each of U.S. patent application Ser. Nos. 11/266,835, filed Nov. 4, 2005, 12/424,182, filed Apr. 15, 2009, and 12/424,188, filed Apr. 15, 2009, is incorporated herein by reference.

Directional references (e.g., front, rear, upper, lower, upward, downward, left, right, leftward, rightward, top, bottom, above, below, vertical, horizontal, clockwise, counterclockwise, machine direction, upstream and downstream) have been used in this disclosure for ease of understanding and not for the purpose of limiting the scope of this disclosure. Also, in considering the scope of this disclosure, each of the features of this disclosure may be considered in isolation, and in various combinations and subcombinations.

It will be understood by those skilled in the art that while the present disclosure has been discussed above with reference to an exemplary embodiment, various additions, modifications and changes can be made thereto without departing from the spirit and scope of the invention as set forth in the claims.

What is claimed is:

1. A bag comprising:
a bag body comprising a first wall and a second wall opposite the first wall; and
a zipper member comprising
a first zipper profile mounted to the first wall by at least both thermoplastic and thermoset adhesive materials positioned between the first wall and the first zipper profile, a total amount of the thermoplastic adhesive material positioned between the first zipper profile and the first wall exceeding a total amount of the thermoset adhesive material positioned between the first zipper profile and the first wall, and
a second zipper profile mounted to the second wall by at least both thermoplastic and thermoset adhesive materials positioned between the second wall and the second zipper profile, a total amount of the thermoplastic adhesive material positioned between the second zipper profile and the second wall exceeding a total amount of the thermoset adhesive material positioned between the second zipper profile and the second wall;
an opening to an interior of the bag being at least partially defined between the first and second zipper profiles; and
the first and second zipper profiles being configured for being releasably interlocked with one another to at least partially close the opening.

2. The bag according to claim 1, wherein
the thermoset adhesive material positioned between the first zipper profile and the first wall defines an arrangement comprising individual dots; and
the thermoplastic adhesive material positioned between the first zipper profile and the first wall defines an arrangement comprising an elongate bead that is longer than each of the individual dots.

3. The bag according to claim 2, wherein
the thermoset adhesive material positioned between the second zipper profile and the second wall defines an arrangement comprising individual dots; and
the thermoplastic adhesive material positioned between the second zipper profile and the second wall defines an arrangement comprising an elongate bead that is longer than each of the individual dots defined by the thermoset adhesive material positioned between the second zipper profile and the second wall.

4. The bag according to claim 3, further comprising a slider mounted to the zipper member for being moved back and forth along the zipper member for opening and closing the opening.

5. The bag according to claim 1, wherein the thermoplastic and thermoset adhesive materials positioned between the first wall and the first zipper profile are:
adjacent to one another, and
in different arrangements from one another.

6. A bag comprising:
a bag body comprising first and second bag portions; and
a closure mechanism comprising
a first closure part mounted to the first bag portion by adhesive materials having contrasting characteristics, and
a second closure part mounted to the second bag portion;
an opening to an interior of the bag being at least partially defined between the first and second closure parts; and
the first and second closure parts being configured for being releasably connected with one another to at least partially close the opening.

7. The bag according to claim 6, wherein the adhesive materials comprise:
a thermoset adhesive material, and
a thermoplastic adhesive material.

8. The bag according to claim 7, wherein:
the thermoset adhesive material is positioned between the first closure part and the first bag portion;
the thermoplastic adhesive material is positioned between the first closure part and the first bag portion;
a total amount of the thermoplastic adhesive material positioned between the first closure part and the first bag portion exceeds a total amount of the thermoset adhesive material positioned between the first closure part and the first bag portion.

9. The bag according to claim 6, wherein the adhesive materials comprise:
a first type of adhesive material positioned between the first closure part and the first bag portion in a first arrangement; and
a second type of adhesive material positioned between the first closure part and the first bag portion in a second arrangement that differs from the first arrangement.

10. The heat retentive server according to claim 9, wherein:
the first type of adhesive material defines an arrangement comprising individual dots; and
the second type of adhesive material defines an arrangement comprising an elongate bead that is longer than each of the individual dots.

11. The bag according to claim 6, wherein:
the closure mechanism comprises a zipper member;
the first closure part comprises a first zipper profile; and
the second closure part comprises a second zipper profile.

12. The bag according to claim 11, further comprising a slider mounted to the zipper member for being moved back and forth along the zipper member for opening and closing the opening.

13. A method of mounting a closure mechanism to a bag comprising first and second bag portions, the method comprising:
mounting a first closure part of the closure mechanism to the first bag portion, comprising
applying first adhesive material to at least one of the first closure part and the first bag portion,
applying second adhesive material to at least one of the first closure part and the first bag portion,
forcing the first closure part and the first bag portion together so that each of the first and second adhesive materials is positioned between, and in contact with both, the first closure part and the first bag portion,
the first adhesive material bonding the first closure part and the first bag portion together,
the second adhesive material bonding the first closure part and the first bag portion together, and
the bonding of the first closure part and the first bag portion together by the first adhesive material occurring more quickly than the bonding of the first closure part and the first bag portion together by the second adhesive material; and
mounting a second closure part of the closure mechanism to the second bag portion, the first and second closure parts being configured for being releasably connected with one another to at least partially close an opening to an interior of the bag.

14. The method according to claim 13, wherein:
the mounting of the first closure part of the closure mechanism to the first bag portion and the mounting of the second closure part of the closure mechanism to the second bag portion occur substantially simultaneously; and the applying of the first adhesive material and the applying of the second adhesive material occur substantially simultaneously.

15. The method according to claim 13, wherein the applying of the first adhesive material and the applying of the second adhesive material comprise applying the first and second adhesive materials in different arrangements from one another.

16. The method according to claim 13, wherein the applying of the first adhesive material and the applying of the second adhesive material comprise applying one of the first and second adhesive materials above the other of the first and second adhesive materials.

17. The method according to claim 13, wherein the applying of the first adhesive material and the applying of the second adhesive material comprise applying the first and second adhesive materials proximate to one another.

18. The method according to claim 17, wherein the applying of the first adhesive material and the applying of the second adhesive material comprise applying the first and second adhesive materials adjacent to one another.

19. The method according to claim 13, comprising, at a predetermined time after the mounting of the first closure part to the first bag portion, a bond defined by the second adhesive material between the first closure part and the first bag portion being stronger than a bond defined by the first adhesive material between the first closure part and the first bag portion.

20. The method according to claim 13, comprising, at a predetermined time after the mounting of the first closure part to the first bag portion, a bond defined by the second adhesive material between the first closure part and the first bag portion having greater high temperature stability than a bond defined by the first adhesive material between the first closure part and the first bag portion.

21. The method according to claim 13, wherein:
the first adhesive material comprises a thermoplastic adhesive material; and
the second adhesive material comprises a thermoset adhesive material.
